(19) United States
(12) Patent Application Publication
(10) Pub. No.: US 2002/0194224 A1
(43) Pub. Date: Dec. 19, 2002

(54) System for providing professional services

(76) Inventors: Peter Paul Nicholas Janssen, Qld (AU); Caroline Ann Janseen, Qld (AU); Malcolm Neil Cartwright, Qld (AU)

Correspondence Address: YOUNG & THOMPSON, 745 SOUTH 23RD STREET 2ND FLOOR, ARLINGTON, VA, 22202

(21) Appl. No.: 10/149,192

(22) PCT Filed: Dec. 11, 2000
(86) PCT No.: PCT/AU00/01528

(30) Foreign Application Priority Data
Dec. 10, 1999 (AU) PQ 4608

(51) Int. Cl. G06F 15/00

(52) U.S. Cl. 707/513

(57) ABSTRACT

A system for providing professional services is provided. The system comprises jurisdiction selection means for selecting a jurisdiction, service selection means for selecting a professional service from a plurality of professional services available for the selected jurisdiction, and means for supplying the selected services. The professional services may be grouped according to categories and category selection means is arranged for selecting a category for a required professional services. The invention may also have means for obtaining information for incorporation into the selected professional service. The system has a document creation means adapted to automatically create a document for a selected jurisdiction using the information obtained from a user. An affiliate matching arrangement is provided for matching professional services with the affiliated professionals responsible for the services and an affiliate payment arrangement is adapted to distribute payment revenues to the affiliate professionals. The system is arranged to be accessible on the Internet.

### TECHNICAL FIELD OF THE INVENTION

This invention relates to a system for providing professional services which are selectable for jurisdiction compliance and in particular but not limited the system is arranged to automatically create and deliver legal documents for selected jurisdictions.

### BACKGROUND ART

Professionals such as accountants, architects, business consultants, engineers, lawyers and medical practitioners, provide their services for particular regions. They do not, in general, provide services outside their regions as they may not be familiar with legal or regulatory requirements for or are not qualified to provide professional services in those regions.

When a person needs a professional service for use in a region outside where the person lives, a professional in the outside region can be found only through extensive searches using resources including telephone directories, the consulate for said outside region, the Internet, etc. Alternatively the person can approach a local professional for referral to a professional in said outside region.

The searching option is time consuming and a number of attempts may be needed before the professional who can provide the required service is found. The referral option requires finding a local professional who has a contact who can provide the professional service.

Many professional services involve creating documents such as legal documents (wills, power of attorney, contracts, agreements, etc.), building designs and plans, business schemes and plans, engineering designs, and the like. In general these documents are created using information obtained at interviews with persons who require the services. These services therefore requires professionals to spend considerable time at interviews and in creating the required documents. As a consequence the costs for these services are high.

The applicant is aware of certain Internet web sites that offer legal documents online. But these documents are for a single jurisdiction only

As used herein this specification, the term “jurisdiction” is intended to include legal jurisdiction, region, country, province or state, city, council or municipality, and the like.

### OBJECT OF THE INVENTION

It is an object of the present invention to provide a system for providing professional services which alleviates at least to some degree of the above mentioned disadvantages of the prior art.

### OUTLINE OF THE INVENTION

In one aspect therefore the present invention resides in a system for providing professional services. The system comprises jurisdiction selection means for selecting a jurisdiction, service selection means for selecting a professional service from a plurality of professional services available for the selected jurisdiction, and means for supplying the selected service.

In another aspect therefore the present invention relates to a computer software for providing professional services. The software comprises jurisdiction selection means for selecting a jurisdiction, service selection means for selecting a professional service from a plurality of professional services available for the selected jurisdiction, and means for supplying the selected service.

It is preferred that the professional services are grouped according to categories. The invention is preferred to include category selection means for selecting a category for a required professional services. Typically the invention is arranged to present the category selection means before the jurisdiction selection means.

The jurisdiction selection means may include a country selector for selecting a country in which a professional service is to be used. Desirably the country selector is arranged to present a list of countries for selection. The jurisdiction selection means may further include a state/province selector for selecting a state/province in the selected country. Similarly, the state/province selector can be arranged to present a list of states/provinces for selection. Where the cities/councils in a state/province have different regulatory requirements the jurisdiction selection means may include a city/council selector for selecting a city/council. Again it is desired that the city/council selector is arranged to present a list of cities/councils for selection.

In preference, the service selection means is arranged to present a list of professional services available for the selected jurisdiction. Where the category selection means is provided the service list is arranged to present professional services available for the selected category and the selected jurisdiction.

Desirably the invention is adapted to include cost indicators for indicating costs for the professional services. Preferably the cost indicators are presented in the list of available services.

The invention may have a selectable guide means for providing guidance for selecting a professional services. The guide means typically is arranged to present sequences for selecting a predetermined professional service to be used in a predetermined jurisdiction.

The invention may have a restart selector for returning to the jurisdiction selection means when the restart selector in selected.

It is preferred that the invention has a secure arrangement for reducing risk of revelation of user information. The secure arrangement may include a secure server running a secure program for encrypting information.

Preferably the invention is arranged to present information about the selected professional service and/or a disclaimer agreement. The invention may be arranged so that the disclaimer agreement must be accepted by a user before the selected professional service is provided.

The invention may have a user identification arrangement for identifying users. The identification arrangement may have a form with fields for user details.

The invention may also have a user verification arrangement for verifying users. The verifying arrangement may have a series of questions and answers which a user must provide in order to access the selected professional service. For a known user the arrangement may present the previously provided questions and the user must provide the same answers for these questions before access is allowed.

The invention may have means for obtaining information for the selected professional service. The information obtaining means may have questions for obtaining appropriate information for the selected service.

The selected professional service may include creating a document for the selected jurisdiction. Preferably the invention has a document creation means adapted to automatically create the document using the obtained information.

The invention may have a service payment arrangement for the selected service. The payment arrangement typically takes place within the secure arrangement for improved security.

The invention may have an affiliate arrangement for matching precessional services with the affiliate professionals responsible therefor. The payment arrangement is adapted to distribute payment revenues between the affiliate professionals and owners of the invention.

The system may include a computer having a storage for storing templates for the documents, and a program is adapted to create a document for the selected service by loading the template appropriate for the document and incorporating the obtained information into the document.

The system may be connectable to a communications network including one or more of the Internet, intranet, local area network, telephone network, television network and the like. A user may access the system using a communications equipment connected to the communications network. Typically the communications equipment is a computer running a communications program for transferring information to and from the system over the communications network.

Desirably the secure arrangement includes a secure computer server running a secure program for encrypting information.

The means for supplying the selected services may include sending information or documents for the selected services to users automatically. This can be sent by email or facsimile. Alternatively the means may include sending information or documents for the selected services by courier or mail.

The invention may include a user assist arrangement for obtaining assistance from an affiliate professional who will be responsible for the selected services. This arrangement may use email, telephone or facsimile service for the assistance.

The invention may also have an incentive arrangement for providing free and/or addition and/or concession services to users agreed to join this arrangement.

### BRIEF DESCRIPTION OF THE DRAWINGS

In order that the present invention can be more readily understood and be put into practical effect reference will now be made to the accompanying drawings which illustrate preferred embodiments of the invention and wherein:

FIG. 1 is a schematic diagram showing the system according to the present invention embodied for access over the Internet;

FIGS. 3 to 13 are selected views on a user's computer when using the system shown in FIG. 2..

### METHOD OF PERFORMANCE

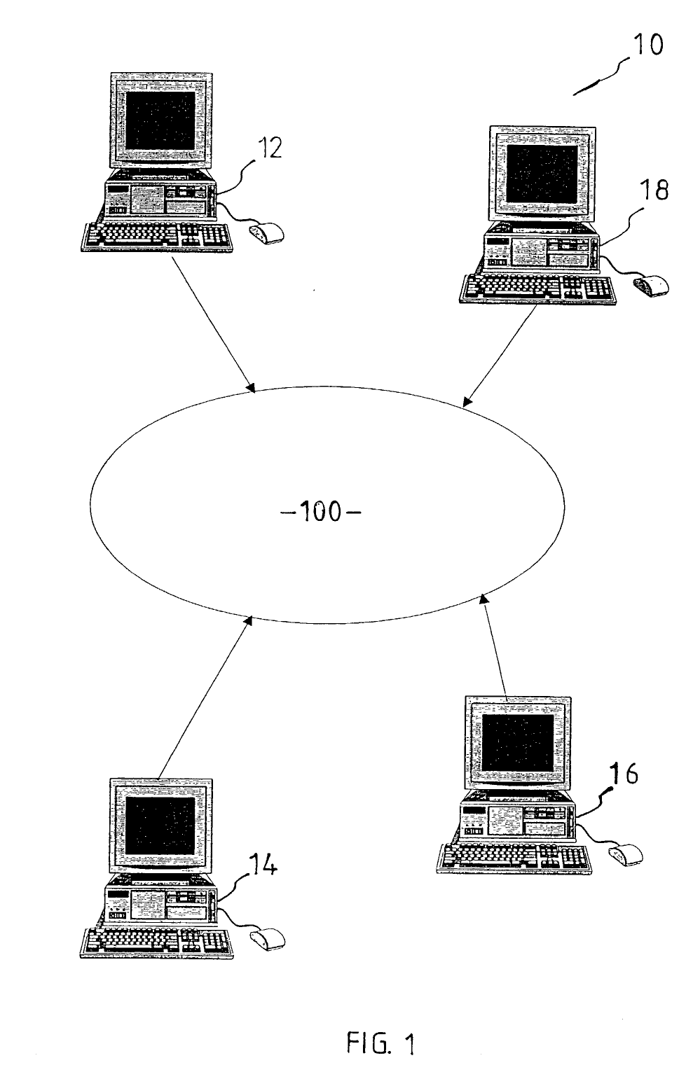

Referring initially there is shown a communications network which in this case is in the form of the Internet 100. The system 10 according to the present invention has a web site on a server 12. The web site includes a home page 20 from which professional services may be obtained. FIG. 1 shows a number of computers of which only 14, 16 and 18 are shown. Any of the computers can access the web site if they have an appropriate communications program such as Microsoft's Internet Explorer or Netscape's Navigator, and a modem connected to a telephone line.

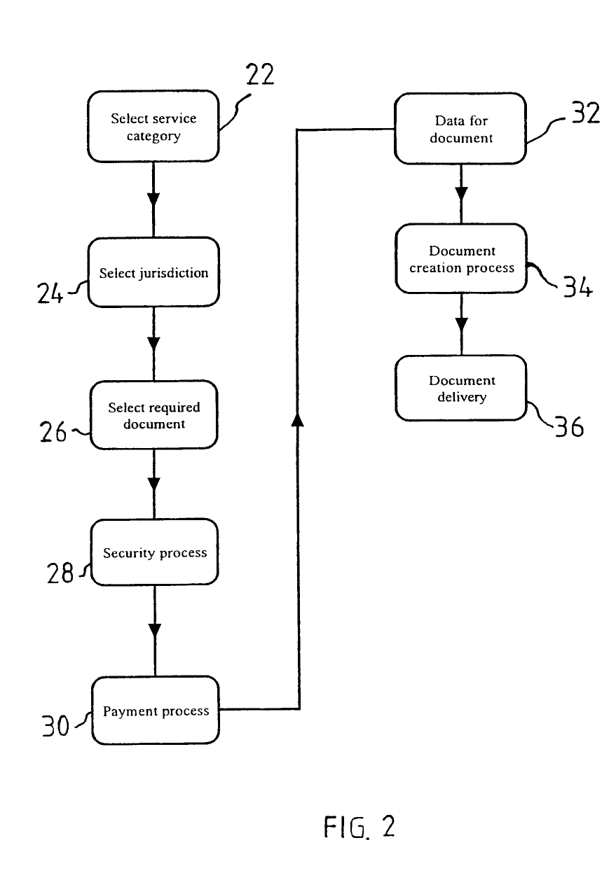

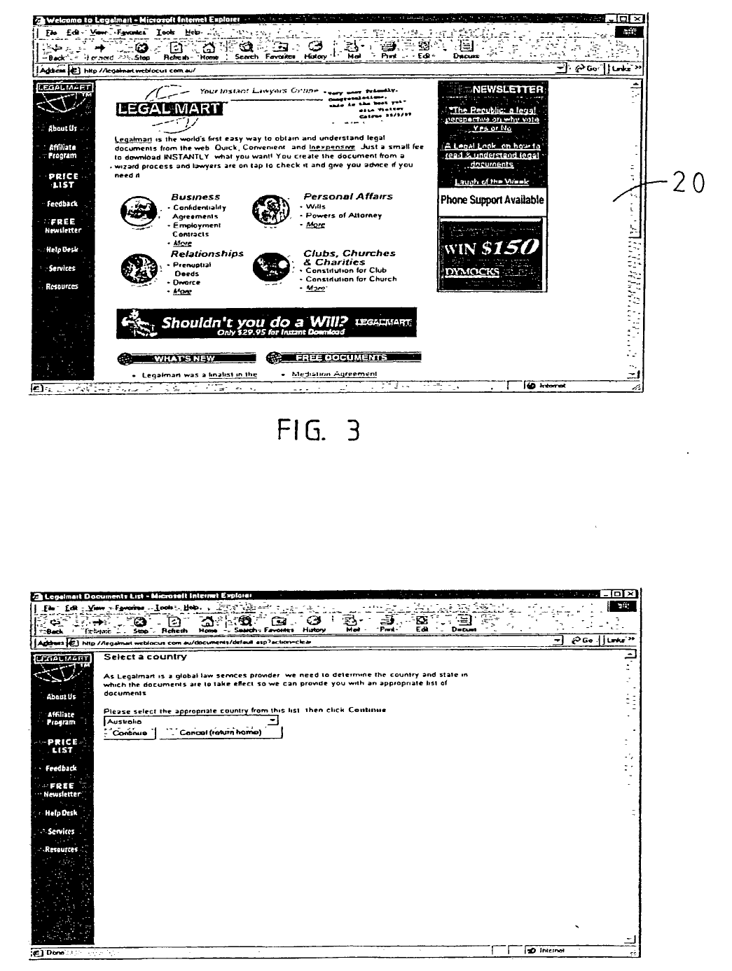

As shown in FIG. 3 when a user say using the computer 14 is in communication with the server 12 for accessing the system 10 of the present invention the server 2 presents the home page 20 on the monitor of the computer 14. From the home page 20 the user may obtain professional services in accordance to the steps shown in FIG. 2. It should be noted that only main steps of the system 10 are shown. In practice the system 10 may have a number of other steps or functionalities within the main steps.

As shown in FIG. 2 the home page 20 displays four service categories namely “Business”, “Personal Affairs”, “Relationship” and “Clubs, Churches & Charities”. The user wishing to obtain a service under “Business” simply positions a mouse pointer over the icon for this category and clicks a button of the pointer. This completes the step 22 for selecting a category.

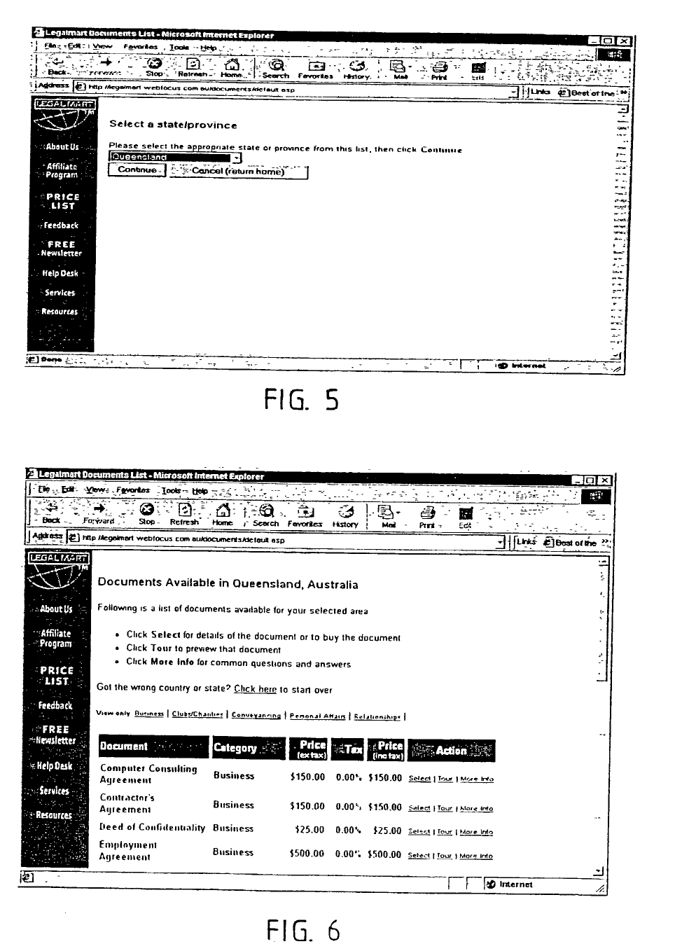

The server 12 then presents forms as shown in FIGS. 4 and 5 for the step 24 for selecting a jurisdiction of the required service. As can be seen in FIG. 4 the user is first prompted to enter a country name or optionally select from a list of available countries.

The user may choose to return to the home page 20 or continue to use the system 10. In this case Australia is selected

When the user chooses to continue the server 12 presents a state selection form as shown in FIG. 5. As for the country selection process the user can either enter the name of the state where he needs to use the service or choose from a list of available states for the selected country. Queensland is selected in this case. The user is also given the option to return to the home page 20 or to continue.

When continuation is chosen the system 10 is at step 26 for the user to select a service which in this case is to obtain a legal document. The server 12 sends data and instructions to computer 14 for displaying a list of business services for Queensland in Australia as shown in FIG. 6. The list also contains charges for the services.

The user may select any one of the services on the list. If more information on a particular service is required the user may simply click on the “More info” button for a description of the service. Clicking on the “Tour” button will present an arrangement which shows the steps for the system 10.

On selection of a service on the list the system 10 uses a secure server running a secure program at step 28 which usually has an encryption scheme so that the information supplied to and from the user can not be easily revealed. All information between the user and the system 10 are now in the secure mode.

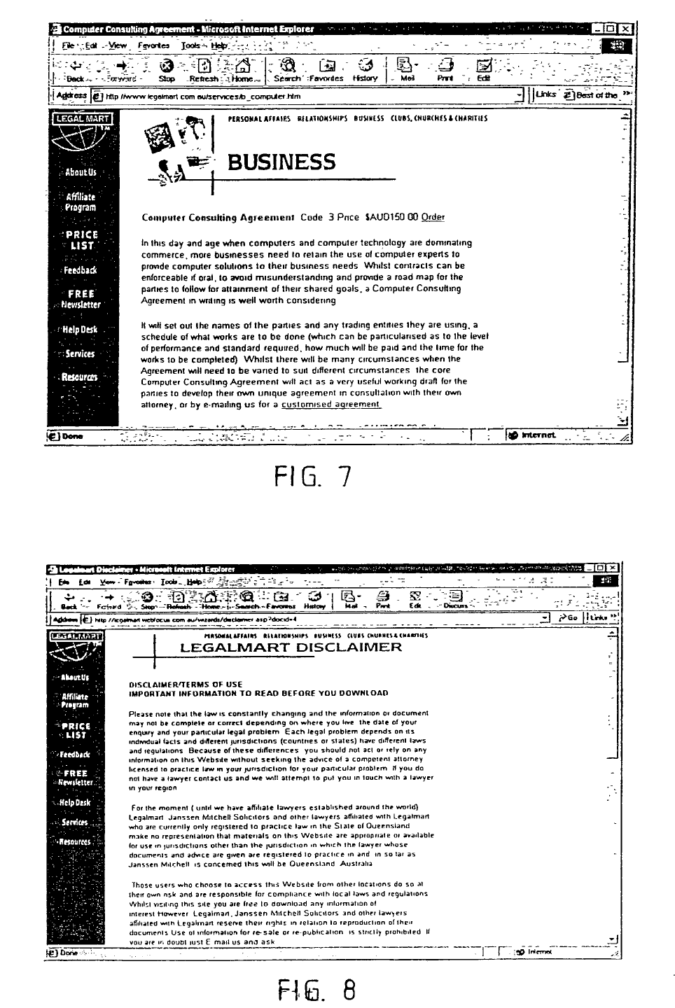

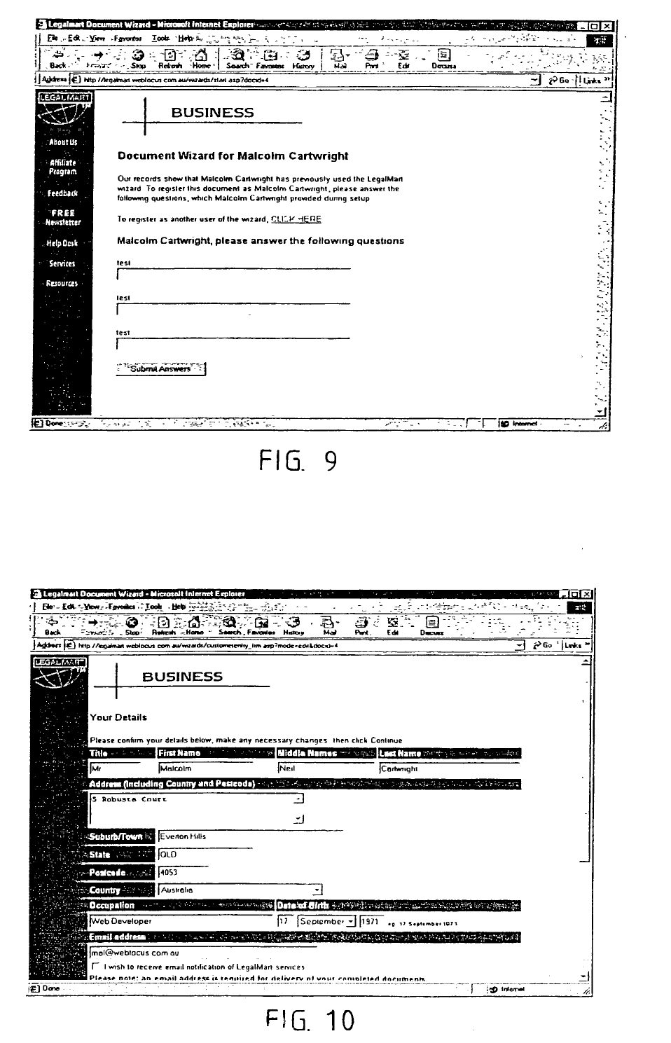

The system 10 displays a full description of the selected business agreement (see FIG. 7) and the costs for the document. The user may choose to order the document or ask for a customised agreement by email.

When the user click on the “Order” button the system 10 takes the user to a disclaimer agreement as shown in FIG. 8. A transaction will take place only when the agreement is accepted by clinking on the “Yes” button.

At the payment step 30, the user is asked to supply three sets of questions and answers as means for identifying the user. If the user has used the system 10 before the questions supplied previously will be shown and the same answers supplied previously must be provided. The system 10 will not progress further if answers are not provided.

Where the answers, if a known user or the questions and answers, if a new user, are provided the system 10 presents a form as shown in FIG. 10 for user details. If the user is known the user details will be presented in the appropriate fields in the form. This user may change any of the details.

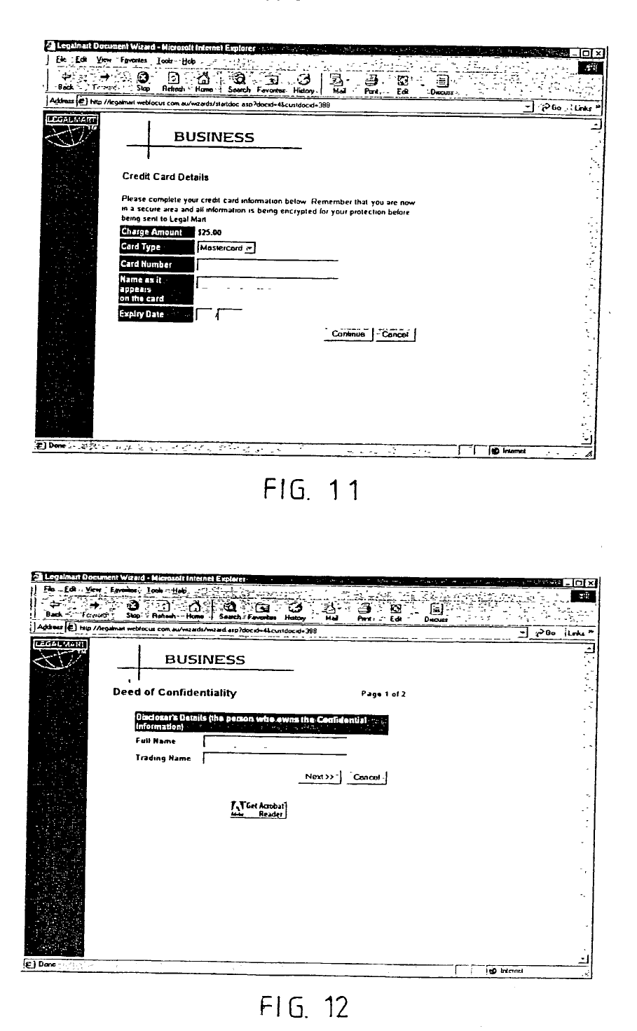

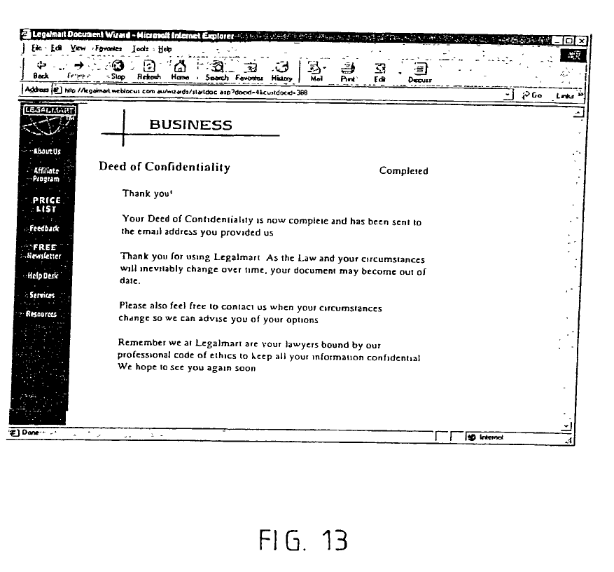

A form (see FIG. 11) for entering the user's credit card details is then shown to the user. This form must be completed before progressing to the step 32 for obtaining information for the selected business agreement.

The step 32 for obtaining information for the selected usually have a number of forms for the user to provide specific for the agreement. FIG. 12 shows one of the forms.

When the information for the selected agreement is obtain the system 10 enters step 34 in which a computer program is used to retrieve the document template for the selected agreement and place pieces of the obtained information in appropriate locations in the agreement.

Step 36 is then entered. This step sends the created agreement for the user to the supplied email address and to the affiliate professional who created the template.

The payment process step 30 will also automatically appropriate revenues between the affiliate professional who created the agreement template and the owners of the system 10.

Whilst the above has been given by way of illustrative example of the present invention many variations and modifications thereto will be apparent to those skilled in the art without departing from the broad ambit and scope of the invention as herein set forth.

1. A system for providing professional services comprising jurisdiction selection means for selecting a jurisdiction, service selection means for selecting a professional service from a plurality of professional services available for the selected jurisdiction, and means for supplying the selected service.

2. A computer software for providing professional services comprising jurisdiction selection means for selecting a jurisdiction, service selection means for selecting a professional service from a plurality of professional services available for the selected jurisdiction, and means for supplying the selected service.

3. The invention according to claim 1 or 2 wherein the professional services are grouped according to categories, and further comprising category selection means for selecting a category for a required professional services.

4. The invention according to any one of claims 1 to 3 wherein the jurisdiction selection means including a country selector for selecting one of a number of countries in which a professional service is intended to be used.

5. The invention according to claim 4 wherein the jurisdiction selection means further including a state/province selector for selecting one of a number of states/provinces in the selected country.

6. The invention according to claim 4 or 5 wherein the jurisdiction selection means including a city/council selector for selecting one of a number of cities/councils.

7. The invention according to any one of claims 1 to 6 wherein the invention is adapted to include cost indicators for indicating costs for any of the professional services available for selection.

8. The invention according to any one of claims 1 to 7 further comprising a selectable guide means for providing guidance for selecting a professional services.

9. The invention according to claim 8 wherein the guide means is arranged to present sequences for selecting a predetermined professional service to be used in a predetermined jurisdiction.

10. The invention according to any one of claims 1 to 9 further comprising a secure arrangement for reducing risk of revelation of user information, the secure arrangement including a secure server running a secure program for encrypting information.

11. The invention according to any one of claims 1 to 10 wherein the invention is arranged to present information about the selected professional service and/or a disclaimer agreement and the invention is arranged so that the disclaimer agreement must be accepted by a user before the selected professional service is provided.

12. The invention according to any one of claims 1 to 6 wherein the invention having a user identification arrangement for identifying users and a user verification arrangement for verifying users.

13. The invention according to claim 12 wherein the verifying arrangement having a series of questions and answers which a user must provide in order to access the selected professional service.

14. The invention according to claim 13 wherein where the identification arrangement identifies a known user the verification arrangement is adapted to present the previously provided questions and to check for matching user provided answers and stored answers before access is allowed.

15. The invention according to any one of claims 1 to 14 further comprising means for obtaining information for the selected professional service, the information obtaining means is adapted to provide one or more questions for obtaining appropriate information for the selected service.

16. The invention according to claim 15 wherein the selected professional service including creating a document for the selected jurisdiction and having a document creation means adapted to automatically create the document using the obtained information.

17. The invention according to claim 10 further comprising the secure arrangement including a service payment procedure for processing payment for the selected service.

18. The invention according to any one of claims 1 to 17 further comprising an affiliate arrangement for matching professional services with affiliated professionals responsible for providing the services, and an affiliate payment arrangement is adapted to distribute payment revenues to the affiliated professionals.

19. The invention according to any one of claims 1 to 18 wherein the invention having a storage means for storing templates for the documents, and a program is adapted to create a document for the selected service by loading the template appropriate for the document and incorporating the obtained information into the document.
